(19) United States
(12) Patent Application Publication
(10) Pub. No.: US 2020/0125070 A1
(43) Pub. Date: Apr. 23, 2020

(54) METHODS, SYSTEMS, APPARATUSES, AND DEVICES FOR FABRICATING 3D PRINTED DENTAL PROSTHESES

(71) Applicant: Jack T. Krauser, West Palm Beach, FL (US)

(72) Inventor: Jack T. Krauser, West Palm Beach, FL (US)

(21) Appl. No.: 16/658,397

(22) Filed: Oct. 21, 2019

Related U.S. Application Data
(60) Provisional application No. 62/747,817, filed on Oct. 19, 2018.

(51) Int. Cl. G05B 19/4099; B33Y 50/00; B33Y 30/00; B33Y 80/00; B29C 64/386; A61C 13/00; A61C 13/34

(52) U.S. Cl. CPC G05B 19/4099; B33Y 50/00; B33Y 30/00; B33Y 80/00; B29C 64/386; B29L 2031/7532; A61C 13/0019; A61C 13/34; G05B 2219/35134; G05B 2219/49008; A61C 13/0004

(57) ABSTRACT

Further disclosed herein is a flowchart of a method for fabricating prosthesis using a 3D printing device, in accordance with some embodiments. Accordingly, the system may include a communication device configured for receiving at least one scanning data from at least one scanning device. Further, the communication device may be configured for transmitting the at least one prosthetic fabrication data to a 3D printer. Further, the 3D printer may be configured to fabricate at least one prosthesis based on the at least one prosthetic fabrication data. Further, the system may include a processing device configured for analyzing the at least one scan data. Further, the processing device may be configured for generating at least one prosthetic fabrication data based on the analyzing. Further, the system may include a storage device configured for storing the at least one prosthetic fabrication data in a database.

### FIELD OF THE INVENTION

Generally, the present disclosure relates to the field of printing. More specifically, the present disclosure relates to methods, systems, apparatuses, and devices for fabricating 3D printed dental prostheses.

### BACKGROUND OF THE INVENTION

The 3D printer is a machine allowing the creation of a physical object from a three-dimensional digital model, typically by laying down many thin layers of a material in succession. 3D printing or additive manufacturing is a process of making three dimensional solid objects from a digital file. Further, the 3D printer may help in fabricating prostheses of various parts of human body.

Existing techniques for 3D printing are deficient with regard to several aspects. For instance, current technologies do not utilize high-performance polymer material for the creation of a prosthesis model. Furthermore, current technologies have high operational costs. Moreover, current technologies take prolonged time in printing the prostheses model. Further, the current technologies require more labor work for its operation.

Therefore, there is a need for improved methods, systems, apparatuses and devices for fabricating 3D printed dental prostheses that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a system configured for fabricating prosthesis, in accordance with some embodiments. Further, the system may include a communication device, a storage device, a processing device, and a 3D printing device. Further, the 3D printing device may be configured for fabricating prosthesis. Further, the 3D printing device may include the communication device communicatively coupled with at least one scanning device. Further, the communication device may be configured for receiving at least one scan data from the at least one scanning device. Further, the scanning device may be configured to generate the at least one scan data. Further, the processing device may be configured for analyzing the at least one scan data. Further, the processing device may be configured generating, at least one prosthetic fabrication data based on the analyzing. Further, the 3D printing device may include a 3D printer communicatively coupled with the processing device. Further, the 3D printer may be configured for fabricating at least one prosthesis based on the at least one prosthetic fabrication data. Further, the storage device may be configured for storing the at least one prosthetic fabrication data.

Further disclosed herein is a system configured for fabricating dental prosthesis, in accordance with some embodiments. Further, the system may include a communication device, a storage device, a processing device and a 3D printing device. Further, the 3D printing device configured for fabricating dental prosthesis. Further, the 3D printing device may include the communication device communicatively coupled with at least one scanning device. Further, the communication device may be configured for receiving at least one scan data from the at least one scanning device. Further, the scanning device may be configured to generate the at least one scan data. Further, the processing device may be configured for analyzing the at least one scan data. Further, the processing device may be configured for generating at least one prosthetic fabrication data based on the analyzing. Further, the 3D printer may be communicatively coupled with the processing device. Further, the 3D printer may be configured to fabricate at least one dental prosthesis based on the at least one prosthetic fabrication data. Further, the storage device may be configured for storing the at least one prosthetic fabrication data.

Further disclosed a method for fabricating prosthesis using a 3D printing device, in accordance with some embodiments. Accordingly, the system may include a communication device configured for receiving at least one scanning data from at least one scanning device. Further, the at least one scanning device may be configured to generate the at least one scan data. Further, the communication device may be configured for transmitting the at least one prosthetic fabrication data to a 3D printer. Further, the 3D printer may be configured to fabricate at least one prosthesis based on the at least one prosthetic fabrication data. Further, the system may include a processing device configured for analyzing the at least one scan data. Further, the processing device may be configured for generating at least one prosthetic fabrication data based on the analyzing. Further, the system may include a storage device configured for storing the at least one prosthetic fabrication data in a database.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a system configured for fabricating a prosthesis, in accordance with some embodiments.

FIG. 3 is a block diagram of a system configured for fabricating a dental prosthesis, in accordance with some embodiments.

FIG. 4 is a flowchart of a method for fabricating a prosthesis using a 3D printing device, in accordance with some embodiments.

FIG. 5 is a flowchart of a method for retrieving at least one predetermined prosthetic data from a database, in accordance with some embodiments.

FIG. 6 is a flowchart of a method for analyzing at least one patient data, in accordance with some embodiments.

FIG. 7 is a flowchart of a method for transmitting at least one prosthetic refining data to the 3D printer, in accordance with some embodiments.

FIG. 8 is a flowchart of the generalized workflow of a 3D printed dental prosthesis, in accordance with some embodiments.

FIG. 9 is a flowchart of a finish phase workflow of the 3D printed dental prosthesis, in accordance with some embodiments.

FIG. 10 is a flowchart of a finish phase workflow of the 3D printed dental prosthesis, in accordance with some embodiments.

FIG. 11 is a flowchart of a finish phase workflow of the 3D printed dental prosthesis, in accordance with some embodiments.

FIG. 12 is a front photographic view of an unrefined 3D printed dental prosthesis, in accordance with some embodiments.

FIG. 13 is a top photographic view of the unrefined 3D printed dental prosthesis, in accordance with some embodiments.

FIG. 14 is a bottom photographic view of the unrefined 3D printed dental prosthesis, in accordance with some embodiments.

FIG. 15 is a bottom photographic view of an unrefined 3D printed dental prosthesis, in accordance with some embodiments.

FIG. 16 is a top photographic view of the unrefined 3D printed dental prosthesis, in accordance with some embodiments.

FIG. 17 is a bottom photographic view of the unrefined 3D printed dental prosthesis, in accordance with some embodiments.

FIG. 18 is a perspective view of a refined 3D printed dental prosthesis, in accordance with some embodiments.

FIG. 19 is a front view of a 3D printed dental prosthesis, in accordance with some embodiments.

FIG. 20 is a block diagram of a computing device for implementing the methods disclosed herein, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context for fabricating 3D printed dental prosthesis by incorporating specific high-performance polymers, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer etc.) and/or possession of a machine-readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data there between corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes systems, apparatuses, and devices for fabricating 3D printed dental prostheses. The present disclosure aims to provide a less expensive, quicker, and readily available method of manufacturing dental prosthesis' using 3d printing systems. The present invention 3D prints viable high-performance polymer material into a functional dental prosthesis model, using digital information from X-rays, 3D cone-beams, and/or any other scanning data. Once printed, the product is finalized in the finishing lab, where it is: smoothed, colored, shaded, and cleaned. In another embodiment of the present invention, pre-printed dental prosthesis' can be fabricated and utilized as “in-house” templates similar to a denture clinic that accommodates one-hour denture services. Accordingly, the frame is printed and the teeth can be attached to the laboratory. Further, the teeth can be stock, custom printed, and/or custom milled from a wide variety of dental materials.

The present invention is a production process for producing readily installable 3D printed dental prostheses'. More specifically, the production process produces dental prostheses' that can account for full arch reconstructions, and/or full jaw constructions. In the preferred embodiment of the present invention, the 3D printed dental prosthesis is made out of a Poly-aryl-ether-ketone (PAEK) polymer in all of its forms and variants. Various polymers such as Poly-ether-ether-ketone (PEEK), and/or Poly-ether-ketone-ketone (PEKK), and/or any other viable 3D printable polymer that can adhere to dental filler materials easily can also be used. In the preferred embodiment of the present invention, the production process utilizes 3D printing processes in all of its forms with powder and binder-based 3D Printing, with the polymers mentioned. The production process comprises a survey, a replicate, a finish, and an installation phase.

The survey phase commences the production process. More specifically, the survey phase records patient data into a readily usable format sufficient for 3D printing machines associated with rapid prototyping. In the preferred embodiment of the present invention, the scan incorporates digital recording means of recording patient data for full arch reconstructions, and/or full jaw constructions. These digital scans can be Digital Imaging and Communications in Medicine (DICOM) scans, particularly X-rays and CT-scans. In another embodiment of the present invention, the scan can incorporate a dental analog recording means to further supplement the production process of the 3D dental prosthesis'. The scan comprises a first impression, a second impression, a convert, and a first export.

The first impression is found in the survey phase. More specifically, the first impression serves as the digital recording means of recording patient data for full arch reconstructions, and/or full jaw reconstruction. In the preferred embodiment of the present invention, the first impression utilizes medical/dental DICOM scans for the patient's bones, teeth, and/or any other hard and rigid structure of interest. Additionally, the first impression utilizes STL scanners to produce digital patient data of the gums and organic soft tissues of the patient's mouth.

The second impression can be incorporated in to the survey phase in conjunction with the first impression. More specifically, the second impression is an analog means of recording patient data for full arch reconstruction, and/or full jaw reconstruction that can serve as a supplemental form of patient data that can be used for further dental prosthesis refinement. The second impression records the negative imprint of the patient's teeth and soft tissues in the mouth via a dental semi-solid mold compound, where a cast can then be formed from the negative imprint.

The convert step of the survey phase proceeds after patient data is acquired from the first impression and the second impression steps. More specifically, the convert step inputs the patient data into an appropriate 3D modeling software, such that formatted files associated with the corresponding fabrication systems are created. In the preferred embodiment of the present invention, the formatted files take the form of STL files associative with 3D printing machines. In another embodiment of the present invention, the patient data can be formatted in CAM files for milling purposes.

The first export step of the survey phase proceeds after the patient data was converted to the appropriate fabrication file formats. More specifically, the first export sends off the formatted patient data to the fabricator lab.

The replicate phase proceeds after the survey phase, specifically commencing after the first export. More specifically, the replicate phase utilizes the refined patient data from the survey phase to fabricate and/or materialize the dental prosthesis. In the preferred embodiment of the present invention, the replicate phase utilizes corresponding 3D printing machines suited for the rapid development of prototypes, particularly machines relating to powder and binder-based 3D printing. In the preferred embodiment of the present invention, the 3D printed material takes form of PAEK polymer in all of its forms and variants viable for dental filler adhesion. The replicate phase comprises a first import, a transmute, and a second export. The first import commences the replicate phase, specifically utilizing patient data from the first export. More specifically, the first import inputs fabricator appropriate data into the 3D printer machine. In the preferred embodiment of the present invention, the first import takes form of printable STL formats. In another embodiment of the present invention, the first import can also contain CAM formats for computerized milling purposes. The transmute step proceeds the first import step. More specifically, the transmute converts the STL format into readily workable fabrication coded instructions for the 3D printer machine to build the 3D printed dental prosthesis based on first import parameters. In the preferred embodiment of the present invention, the transmute process takes form of instructional g-code, specific into materializing the raw polymer material into a 3D printed dental prosthesis. The second import proceeds after the transmute step. More specifically, the second export sends off the 3D printed dental prosthesis to the finishing lab, associative with the finish phase.

The finish phase proceeds after the replicate phase. More specifically, the finish phase receives the 3D printed dental prosthesis from the replicate, and subjects the 3D printed dental prosthesis to refinement processes to produce a readily place-able dental prosthesis for the installation phase. In the preferred embodiment of the present invention, the finish phase incorporates titanium fasteners that matches the patient data found in the survey phase. Additionally, the finish phase specifically: polishes, smooths, colors, shades, cures, infuses, buffs, and/or polishes the 3D printed dental prosthesis into a readily place-able dental prosthesis. In the preferred embodiment of the present invention, the finish phase comprises the first path. In another embodiment of the present invention, the finish phase can comprise the second path, and the third path.

The first path is found in the finish phase. More specifically, the first path is the customizable finishing sub-set that receives a fully customized 3D printed dental prosthesis from the replicate phase, such that the 3D printed dental prosthesis accounts for: fastening holes, teeth, and/or soft tissue replications. The fastening holes outlined in the 3d printed dental prosthesis serves as pre-positioned slots for the titanium fasteners to attach on. The first path requires a technician to place the 3D printed dental prosthesis on to an articulation device to align the jaw profile meshing, particularly in the open and closed position. The titanium fasteners are then aligned, fixed and adhered on to the outlined fastening holes, in correspondence to the patient data found in the survey phase. The dental prosthetic is then; polished, smoothed, colored, shaded, cured, infused, buffed, and polished to produce a readily place-able final product for the installation phase.

The second path is found in the finish phase. More specifically, the second path is the mass-producible subset that receives a plurality of pre-printed/fabricated standardized dental prosthesis', based standardized jaw shapes i.e. V, U, Square jaw templates, and jaw scales ranging from Small, medium, and large. The pre-printed dental prosthesis will not come with fastener holes outlining the specific fastening positions found in the first path. The technician utilizes patient data from the survey phase to select a corresponding pre-printed/fabricated standardized dental prosthesis. The selected dental prosthesis will be relational to the shape and positioning of survey phase data, particularly matching with the digital readings of the first impression, and/or the analog readings of the second impression. The technician will create the fastening holes and install the fasteners based on patient data. The prepared dental prosthetic is then; polished, smoothed, colored, shaded, cured, infused, buffed, and polished to produce a readily place-able final product for the installation phase.

The third path is found in the finish phase. More specifically, the third is the toothless subset, where the finisher phase receives a 3D printed toothless dental prosthesis. The 3D printed toothless dental prosthesis comprises a plurality of tooth slots, such that customizable teeth can readily install into the slots, using a plurality of pegs. In the preferred embodiment of the present invention, the plurality of tooth slots takes form of rounded rectangle slot dimensions corresponds to the frame. The peg fixes the customizable teeth on to the tooth slot, where the other end attaches to the hollowed-out portions of the customizable teeth. The technician then arranges and fixes the pegs and customizable teeth based on patient data found in the survey phase. In the preferred embodiment of the present invention, the customizable teeth and/or pegs can be 3D printed out ceramic, polymer, and/or any other viable dental material. The technician will create the fastening holes and install the fasteners based on patient data. The prepared dental prosthetic is then; polished, smoothed, colored, shaded, cured, infused, buffed, and polished to produce a readily place-able final product for the installation phase.

The installation phase proceeds after the finish phase. More specifically, the dentist receives the corresponding readily place-able dental prosthesis and professionally fits the dental prosthesis on to the patient.

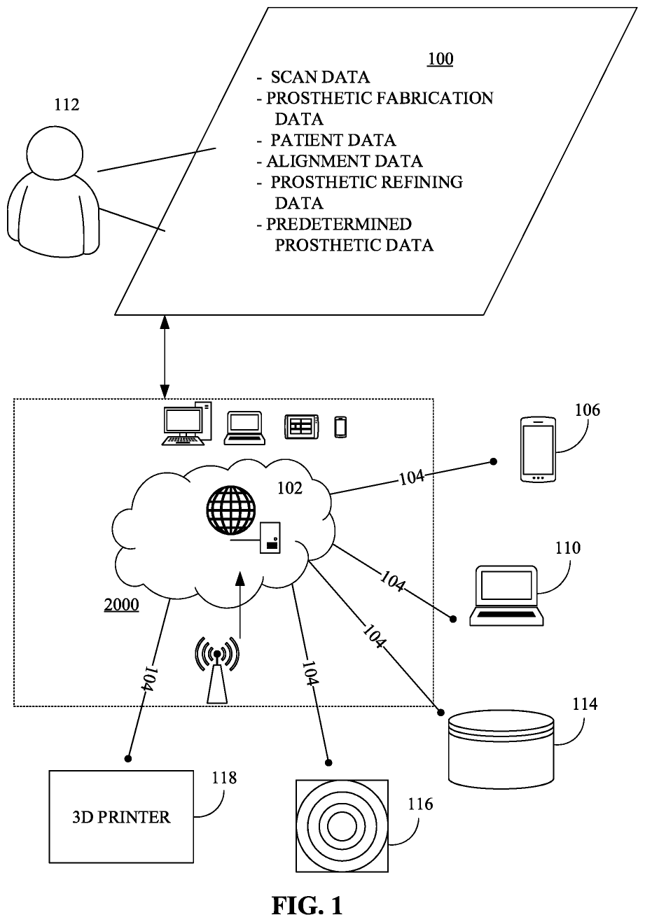

FIG. 1 is an illustration of an online platform 100 consistent with various embodiments of the present disclosure. By way of non-limiting example, the online platform 100 to facilitate operation of a 3D printer 118 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 2000.

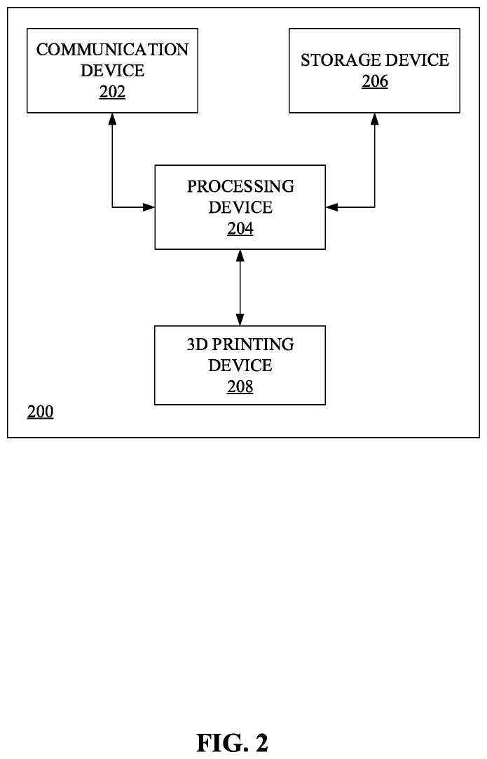

FIG. 2 is a block diagram of a system 200 configured for fabricating a prosthesis, in accordance with some embodiments. Further, the system 200 may include a communication device 202, a storage device 206, a processing device 204 and a 3D printing device 208.

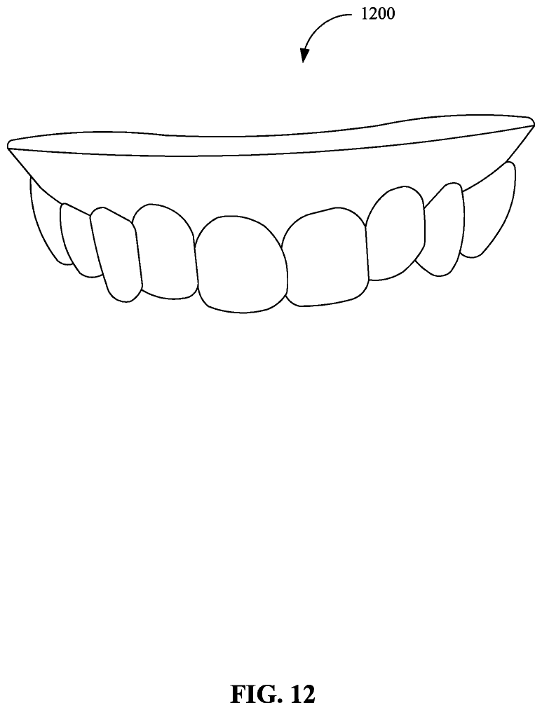

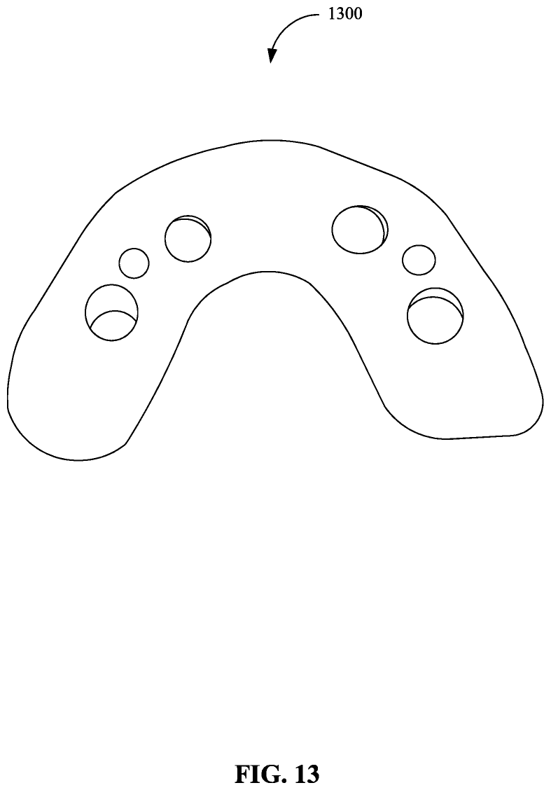

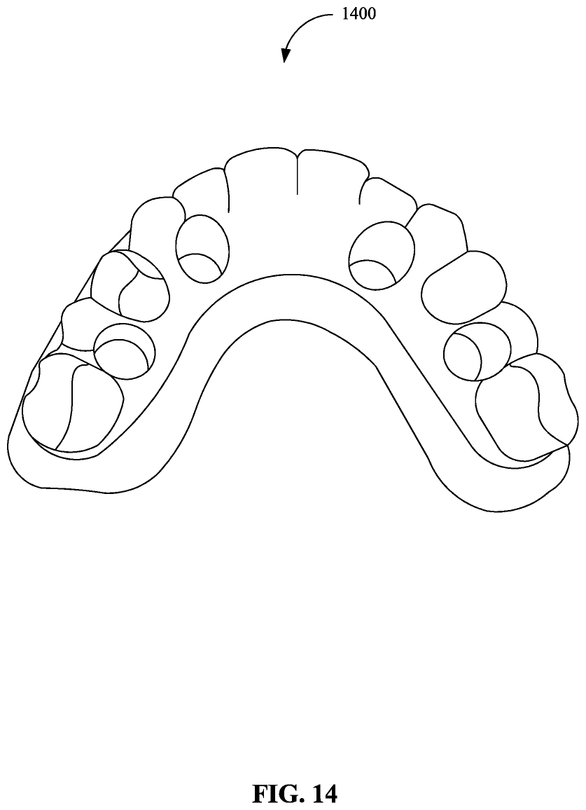

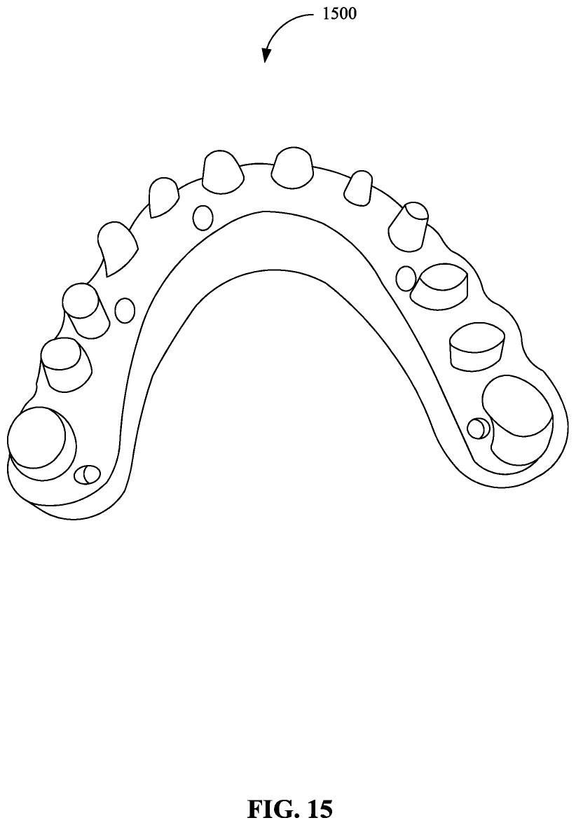

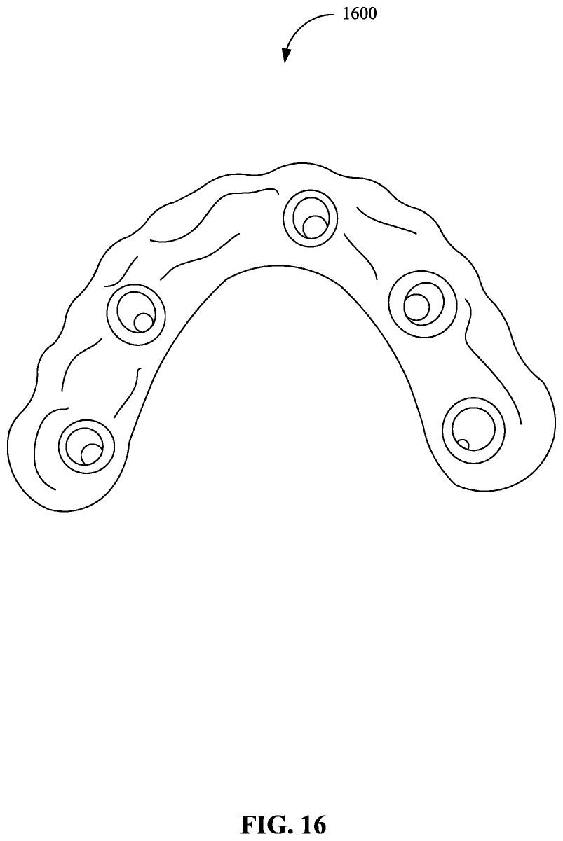

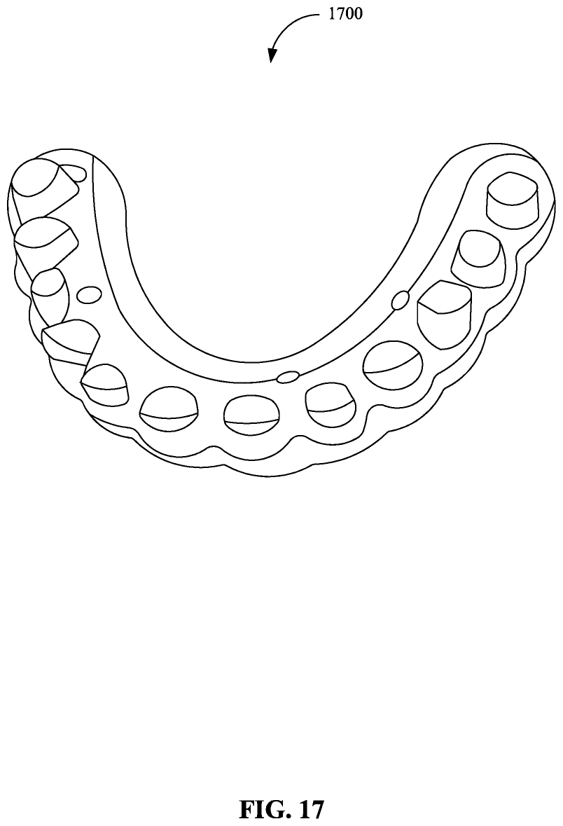

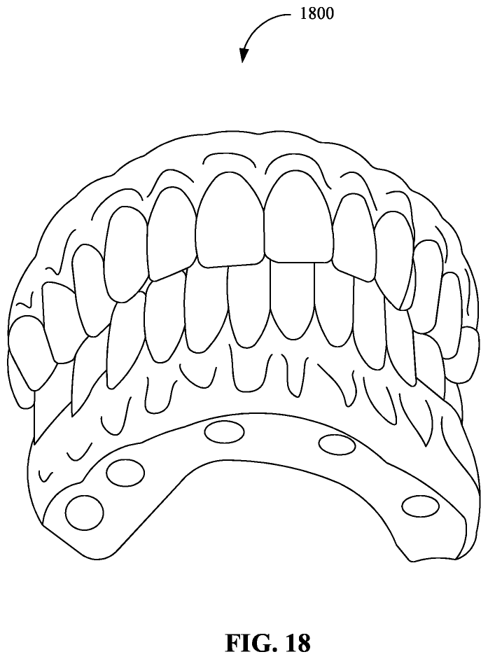

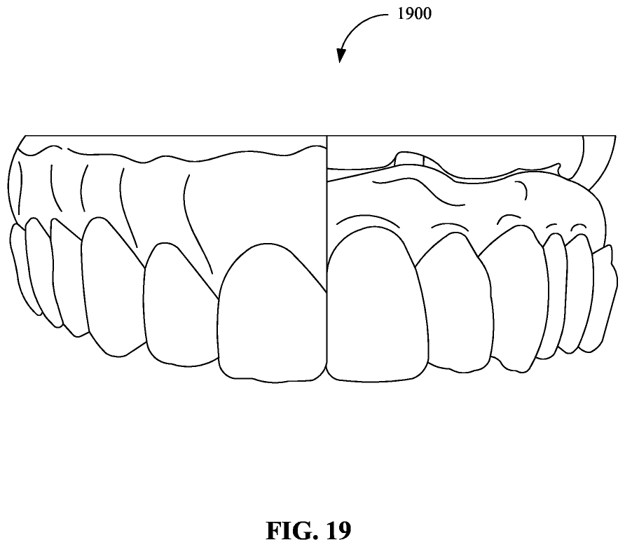

Further, the 3D printing device 208 may be configured for fabricating prostheses. Further, the prosthesis, in an instance, may include dental prostheses as shown in FIG. 12, FIG. 13, FIG. 14, FIG. 15, FIG. 16, FIG. 17, FIG. 18, and FIG. 19. Further, the 3D printing device 208 may include the communication device 202 communicatively coupled with at least one scanning device. In an instance, the at least one scanning device may include a Digital Imaging and Communications in Medicine (DICOM) device, an X-ray device and, a CT-scan device. Further, the communication device 202 may be configured for receiving at least one scan data from the at least one scanning device. In an instance, the at least one scan data may be associated with recording patient's data for a full arch data, and/or a full jaw data of the patient's teeth. Further, the scanning device may be configured to generate the at least one scan data.

Further, the processing device 204 may be configured for analyzing the at least one scan data. Further, the at least one scan data, in an instance, may be converted into at least one prosthetic fabrication data. Further, the processing device 204 may be configured generating, the at least one prosthetic fabrication data based on the analyzing.

Further, the 3D printing device 208 may include a 3D printer communicatively coupled with the processing device 204. In an instance, the 3D printer may fabricate the dental prosthesis based on the at least one prosthetic fabrication data. Further, the 3D printer may be configured for fabricating at least one prosthesis based on the at least one prosthetic fabrication data.

Further, the storage device 206 may be configured for storing the at least one prosthetic fabrication data.

In further embodiments, the processing device 204 configured for identifying at least one predetermined prosthetic indication based on the analyzing.

Further, the storage device 206 may be configured for retrieving the at least one predetermined prosthetic data from a database based on the at least one predetermined prosthetic indication. Further, the processing device 204 may be configured for generating the at least one prosthetic fabrication data based on the at least one predetermined prosthetic data.

Further, in some embodiments, the scanning device may be configured to scan at least one body part of a patient. In an instance, the at least one body part may be associated with an oral cavity. Further, the at least one scan data may be associated with the at least one body part. Further, the at least one prosthesis may be associated with the at least one body part.

Further, in some embodiments, the communication device 202 may be configured for receiving at least one patient data associated with at least one body part of a patient from at least one practitioner device. Further, the at least one practitioner device, in an instance, may include a mobile device 106 (such as a smartphone, a laptop, a tablet computer etc.), other electronic devices 110 (such as desktop computers, server computers etc. Further, the at least one prosthesis may be associated with the at least one body part. Further, the processing device 204 configured for analyzing the at least one patient data.

Further, in some embodiments, the 3D printer may be configured for fabricating at least one precursor prosthesis. Further, the at least one precursor prosthesis, in an instance, may include a pre-dental prosthesis which may be used for aligning the dental prosthesis. Further, the 3D printer further may include the processing device 204 configured for generating at least one alignment data based on the analyzing. Further, the at least one alignment data, in an instance, may be associated with dimensions of the dental prosthesis. Further, the 3D printer may be configured for fabricating the at least one prosthesis based on the at least one alignment data and the at least one precursor prosthesis.

Further, in some embodiments, the at least one prosthesis may include at least one fabricable polymer material. Further, the at least one fabricable polymer material, in an instance, may include a Poly-aryl-ether-ketone (PAEK) polymer, a Poly-ether-ether-ketone (PEEK) polymer, and a Poly-ether-ketone-ketone (PEKK) polymer. Further, the 3D printer may be configured for fabricating the at least one prosthesis using the at least one fabricable polymer material.

In further embodiments, the communication device 202 configured for receiving at least one prosthetic refining data associated with the at least one prosthesis from at least one practitioner device. Further, the 3D printer may be configured for refining the at least one prosthetic based on the at least one prosthetic refining data. Further, the refining, in an instance, may include polishing, smoothing, coloring, shading, curing, infusing, buffing, and polishing of the dental prosthesis.

Further, in some embodiments, the at least one prosthetic fabrication data may include a 3D model of the at least one prosthesis. Further, the 3D printer further may include the communication device 202 configured for transmitting the 3D model to at least one user device. Further, the at least one user device, in an instance, may include a smartphone, a laptop, a tablet computer, etc. Further, the at least one user device may be communicatively coupled with the communication device 202. Further, the at least one user device may be configured to present the 3D model to at least one user.

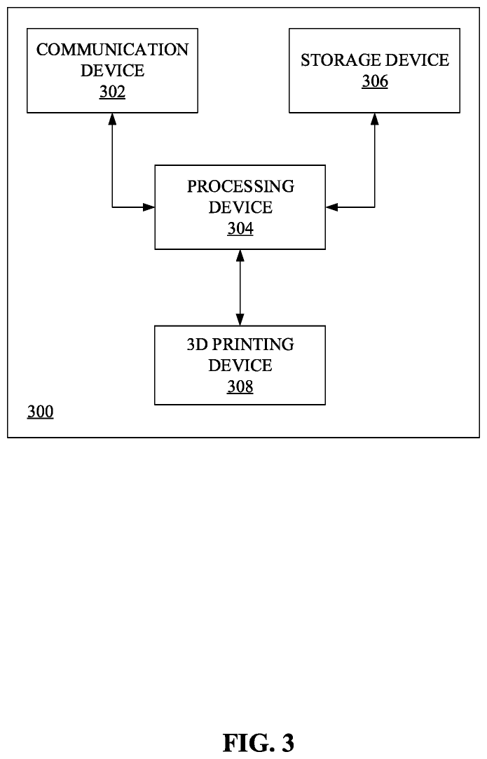

FIG. 3 is a block diagram of a system 300 configured for fabricating a dental prosthesis, in accordance with some embodiments. Further, the system 300 may include a communication device 302, a storage device 306, a processing device 304 and a 3D printing device 308.

Further, the 3D printing device 308 configured for fabricating dental prosthesis. Further, the dental prosthesis, in an instance, may include jaw shape such as, but not limited to, a V-shaped, a U-shaped, a square-shaped, etc., all ranging from small size, medium size, and large size. Further, the 3D printing device 308 may include the communication device 302 communicatively coupled with at least one scanning device. In an instance, the at least one scanning device may include a Digital Imaging and Communications in Medicine (DICOM) device, an X-ray device and, a CT-scan device. Further, the communication device 302 may be configured for receiving at least one scan data from the at least one scanning device. Further, the scanning device may be configured to generate the at least one scan data. In an instance, the at least one scan data may be associated with recording patient's data for full arch data, and/or full jaw data of the patient's teeth.

Further, the processing device 304 may be configured for analyzing the at least one scan data. Further, the processing device 304 may be configured for generating at least one prosthetic fabrication data based on the analyzing.

Further, the 3D printing device 308 may include a 3D printer communicatively coupled with the processing device 304. In an instance, the 3D printer may fabricate the dental prosthesis based on the at least one prosthetic fabrication data. Further, the 3D printer may be configured to fabricate at least one dental prosthesis based on the at least one prosthetic fabrication data.

Further, the storage device 306 may be configured for storing the at least one prosthetic fabrication data.

In further embodiments, the processing device 304 configured for identifying at least one predetermined prosthetic indication based on the analyzing. Further, the storage device 306 configured for retrieving the at least one predetermined prosthetic data from a database based on the at least one predetermined prosthetic data. Further, the processing device 304 may be configured for generating the at least one prosthetic fabrication data based on the at least one predetermined prosthetic data.

Further, in some embodiments, the 3D printer may be configured for fabricating at least one precursor prosthesis. Further, the at least one precursor prosthesis, in an instance, may include a pre-dental prosthesis which may be used for aligning the dental prosthesis. Further, the 3D printer further may include the processing device 304 configured for generating at least one alignment data based on the analyzing. Further, the at least one alignment data, in an instance, may be associated with dimensions of the dental prosthesis. Further, the 3D printer may be configured for fabricating the at least one prosthesis based on the at least one alignment data and the at least one precursor prosthesis.

In further embodiments, the communication device 302 configured for receiving at least one prosthetic refining data associated with the at least one dental prosthesis from at least one practitioner device. Further, the 3D printer configured for refining the at least one dental prosthetic based on the at least one prosthetic refining data.

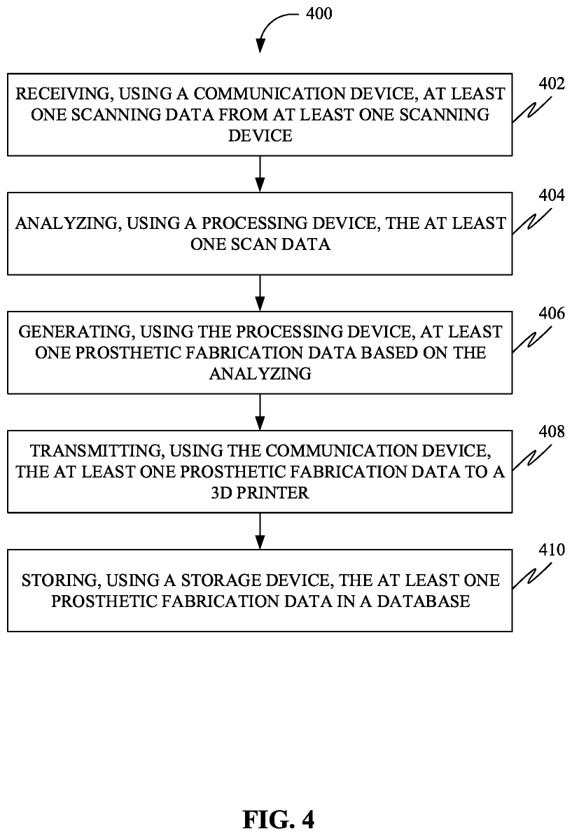

FIG. 4 is a flowchart of a method 400 for fabricating a prosthesis using a 3D printing device, in accordance with some embodiments. Further, the prosthesis, in an instance, may include dental prostheses as shown in FIG. 12, FIG. 13, FIG. 14, FIG. 15, FIG. 16, FIG. 17, FIG. 18, and FIG. 19. Further, at 402, the method 400 may include a step of receiving, using a communication device, at least one scanning data from at least one scanning device. In an instance, the at least one scanning device may include a Digital Imaging and Communications in Medicine (DICOM) device, an X-ray device and, a CT-scan device. Further, the at least one scanning device may be configured to generate the at least one scan data. In an instance, the at least one scan data may be associated with recording patient's data for a full arch data, and/or a full jaw data of the patient's teeth.

Further, at 404, the method 400 may include a step of analyzing, using a processing device, the at least one scan data.

Further, at 406, the method 400 may include a step of generating, using the communication device, at least one prosthetic fabrication data based on the analyzing.

Further, at 408, the method 400 may include a step of transmitting, using the communication device, the at least one prosthetic fabrication data to a 3D printer. Further, the 3D printer may be configured to fabricate at least one prosthesis based on the at least one prosthetic fabrication data.

Further, at 410, the method 400 may include a step of storing, using a storage device, the at least one prosthetic fabrication data in a database.

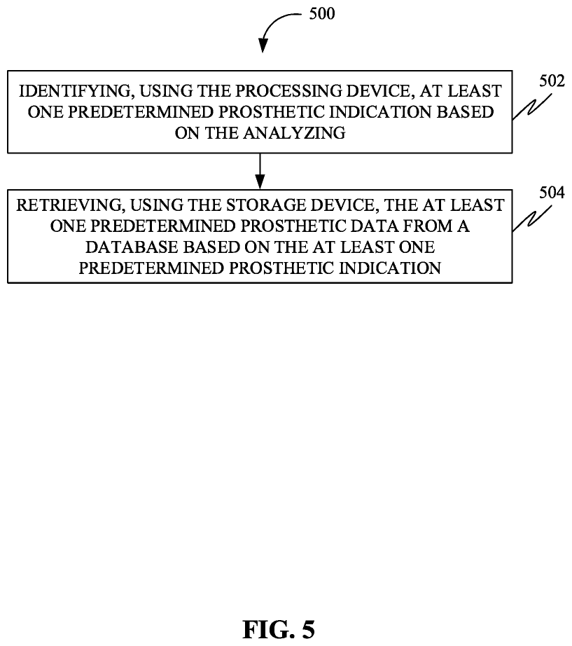

FIG. 5 is a flowchart of a method 500 for retrieving at least one predetermined prosthetic data from a database, in accordance with some embodiments. Further, at 502, the method 500 may include a step of identifying, using the processing device, at least one predetermined prosthetic indication based on the analyzing.

Further, at 504, the method 500 may include a step of retrieving, using the storage device, the at least one predetermined prosthetic data from a database based on the at least one predetermined prosthetic indication. Further, the processing device may be configured for generating the at least one prosthetic fabrication data based on the at least one predetermined prosthetic data.

Further, in some embodiments, the scanning device may be configured to scan at least one body part of a patient. Further, the at least one scan data may be associated with the at least one body part. Further, the at least one prosthesis may be associated with the at least one body part.

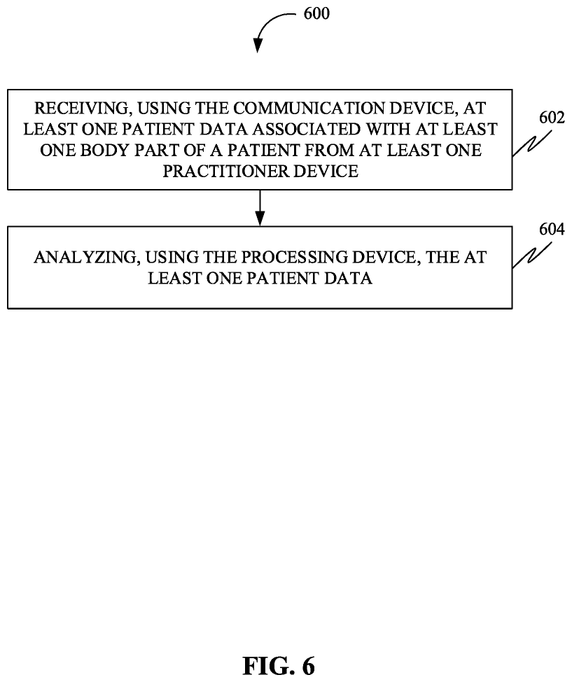

FIG. 6 is a flowchart of a method 600 for analyzing at least one patient data, in accordance with some embodiments. Further, at 602, the method 600 may include a step of receiving, using the communication device, at least one patient data associated with at least one body part of a patient from at least one practitioner device, wherein the at least one prosthesis is associated with the at least one body part.

Further, at 604, the method 600 may include a step of analyzing, using the processing device, the at least one patient data.

Further, in some embodiments, the 3D printer may be configured for fabricating at least one precursor prosthesis. Further, the method further may include generating, using the processing device, at least one alignment data based on the analyzing. Further, the 3D printer may be configured for fabricating the at least one prosthesis based on the at least one alignment data and the at least one precursor prosthesis.

Further, in some embodiments, the at least one prosthesis may include at least one fabricable polymer material. Further, the 3D printer may be configured for fabricating the at least one prosthesis using the at least one fabricable polymer material.

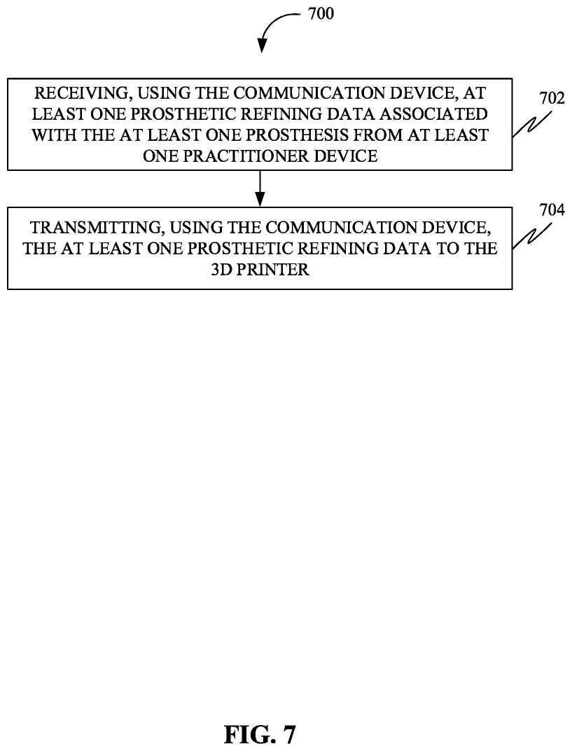

FIG. 7 is a flowchart of a method 700 for transmitting at least one prosthetic refining data to the 3D printer, in accordance with some embodiments. Further, at 702, the method 700 may include a step of receiving, using the communication device, at least one prosthetic refining data associated with the at least one prosthesis from at least one practitioner device.

Further, at 704, the method 700 may include a step of transmitting, using the communication device, the at least one prosthetic refining data to the 3D printer. Further, the 3D printer configured for refining the at least one prosthetic based on the at least one prosthetic refining data.

Further, in some embodiments, the at least one prosthetic fabrication data may include a 3D model of the at least one prosthesis. Further, the method further may include transmitting, using the communication device, the 3D model to at least one user device. Further, the at least one user device may be communicatively coupled with the communication device. Further, the at least one user device may be configured to present the 3D model to at least one user.

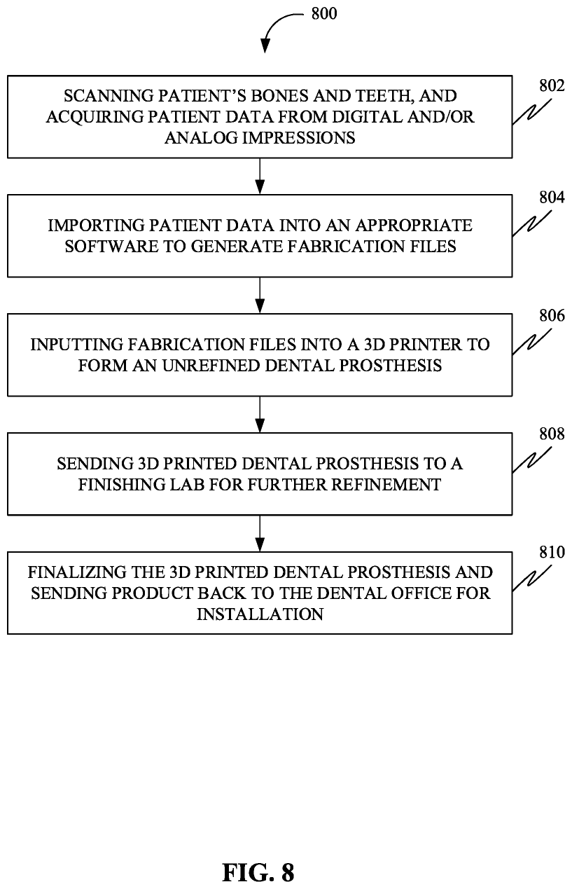

FIG. 8 is a flowchart of a method 800 for the generalized workflow of a 3D printed dental prosthesis, in accordance with some embodiments. Further, at 802, the method 800 may include a step of scanning patient's bones and teeth, and acquiring patient data from digital and/or analog impressions.

Further, at 804, the method 800 may include a step of importing patient data into an appropriate software to generate fabrication files.

Further, at 806, the method 800 may include a step of inputting fabrication files into a 3D printer to form an unrefined dental prosthesis.

Further, at 808, the method 800 may include a step of sending 3D printed dental prosthesis to a finishing lab for further refinement.

Further, at 810, the method 800 may include a step of finalizing the 3D printed dental prosthesis and sending product back to the dental office for installation.

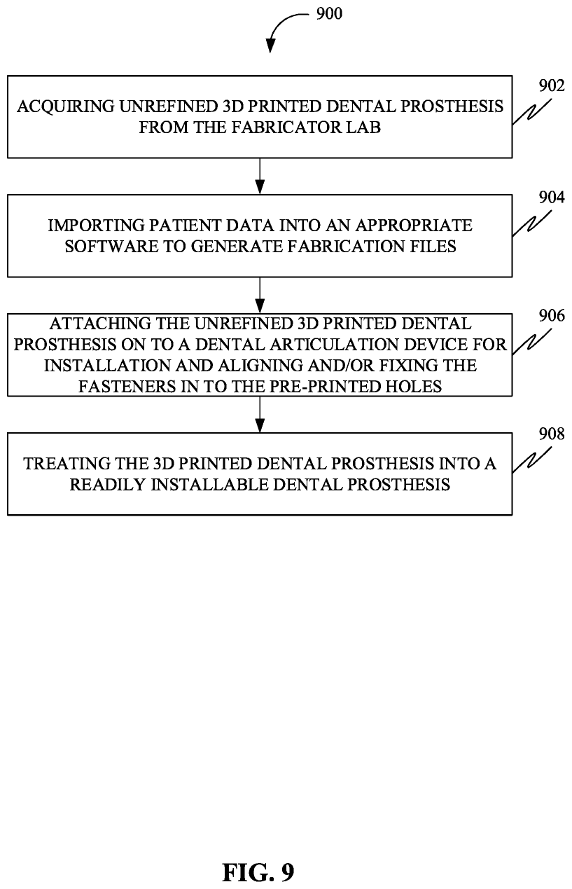

FIG. 9 is a flowchart of a method 900 for finish phase workflow of the 3D printed dental prosthesis, in accordance with some embodiments. Further, at 902, the method 900 may include a step of acquiring unrefined 3d printed dental prosthesis from the fabricator lab.

Further, at 904, the method 900 may include a step of importing patient data into an appropriate software to generate fabrication files.

Further, at 906, the method 900 may include a step of attaching the unrefined 3D printed dental prosthesis on to a dental articulation device for installation and aligning and/or fixing the fasteners in to the pre-printed holes.

Further, at 908, the method 900 may include a step of treating the 3D printed dental prosthesis into a readily installable dental prosthesis.

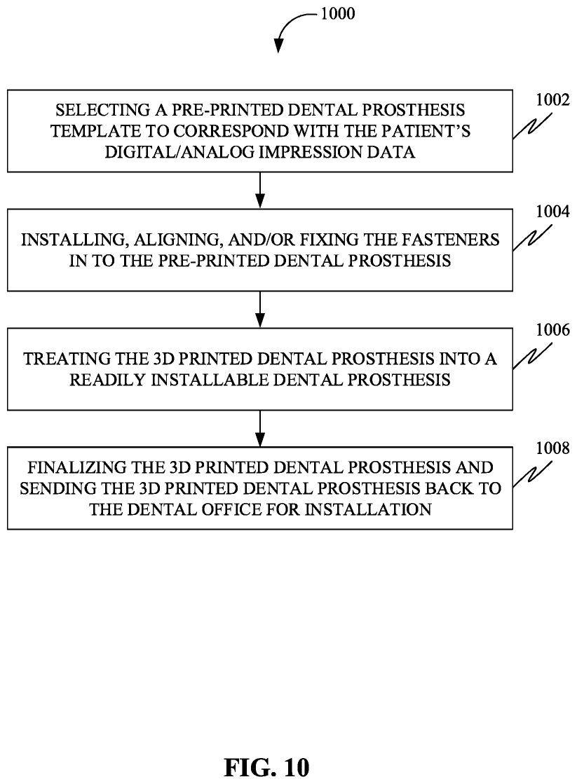

FIG. 10 is a flowchart of a method 1000 for finish phase workflow of the 3D printed dental prosthesis, in accordance with some embodiments. Further, at 1002, the method 1000 may include a step of selecting a pre-printed dental prosthesis template to correspond with the patient's digital/analog impression data.

Further, at 1004, the method 1000 may include a step of installing, aligning, and/or fixing the fasteners in to the pre-printed dental prosthesis.

Further, at 1006, the method 1000 may include a step of treating the 3D printed dental prosthesis into a readily installable dental prosthesis.

Further, at 1008, the method 1000 may include a step of finalizing the 3D printed dental prosthesis and sending the 3D printed dental prosthesis back to the dental office for installation.

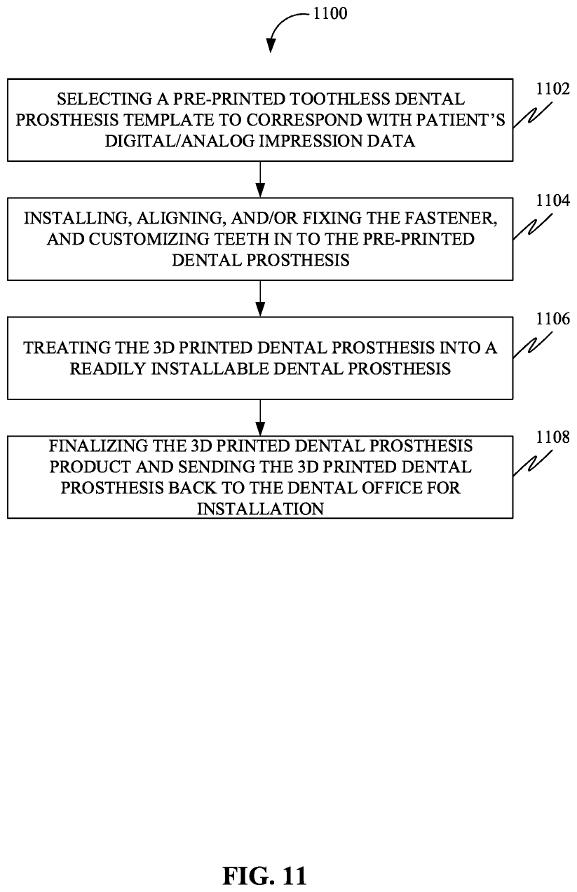

FIG. 11 is a flowchart of a method 1100 for finish phase workflow of the 3D printed dental prosthesis, in accordance with some embodiments. Further, at 1102, the method 1100 may include a step of selecting a pre-printed toothless dental prosthesis template to correspond with patient's digital/analog impression data.

Further, at 1104, the method 1100 may include a step of installing, aligning, and/or fixing the fastener, and customizing teeth in to the pre-printed dental prosthesis.

Further, at 1106, the method 1100 may include a step of treating the 3D printed dental prosthesis into a readily installable dental prosthesis.

Further, at 1108, the method 1100 may include a step of finalizing the 3D printed dental prosthesis product and sending the 3D printed dental prosthesis back to the dental office for installation.

FIG. 12 is a front photographic view of an unrefined 3D printed dental prosthesis 1200, in accordance with some embodiments. FIG. 13 is a top photographic view of the unrefined 3D printed dental prosthesis 1300, in accordance with some embodiments. FIG. 14 is a bottom photographic view of the unrefined 3D printed dental prosthesis 1400, in accordance with some embodiments. FIG. 15 is a bottom photographic view of an unrefined 3D printed dental prosthesis 1500, in accordance with some embodiments. FIG. 16 is a top photographic view of the unrefined 3D printed dental prosthesis 1600, in accordance with some embodiments. FIG. 17 is a bottom photographic view of the unrefined 3D printed dental prosthesis 1700, in accordance with some embodiments. FIG. 18 is a perspective view of a refined 3D printed dental prosthesis 1800, in accordance with some embodiments. FIG. 19 is a front view of a 3D printed dental prosthesis 1900, in accordance with some embodiments.

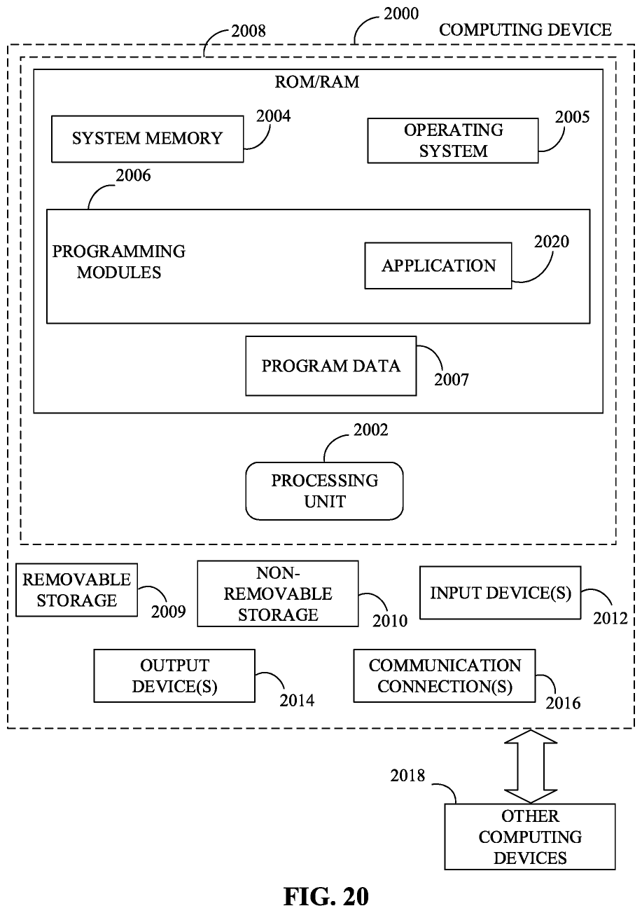

With reference to FIG. 20, a system consistent with an embodiment of the disclosure may include a computing device or cloud service, such as computing device 2000. In a basic configuration, computing device 2000 may include at least one processing unit 2002 and a system memory 2004. Depending on the configuration and type of computing device, system memory 2004 may comprise, but is not limited to, volatile (e.g. random-access memory (RAM)), non-volatile (e.g. read-only memory (ROM)), flash memory, or any combination. System memory 2004 may include operating system 2005, one or more programming modules 2006, and may include a program data 2007. Operating system 2005, for example, may be suitable for controlling computing device 2000's operation. In one embodiment, programming modules 2006 may include image-processing module, machine learning module. Furthermore, embodiments of the disclosure may be practiced in conjunction with a graphics library, other operating systems, or any other application program and is not limited to any particular application or system. This basic configuration is illustrated in FIG. 20 by those components within a dashed line 2008.

Computing device 2000 may have additional features or functionality. For example, computing device 2000 may also include additional data storage devices (removable and/or non-removable) such as, for example, magnetic disks, optical disks, or tape. Such additional storage is illustrated in FIG. 20 by a removable storage 2009 and a non-removable storage 2010. Computer storage media may include volatile and non-volatile, removable and non-removable media implemented in any method or technology for storage of information, such as computer-readable instructions, data structures, program modules, or other data. System memory 2004, removable storage 2009, and non-removable storage 2010 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 2000. Any such computer storage media may be part of device 2000. Computing device 2000 may also have input device(s) 2012 such as a keyboard, a mouse, a pen, a sound input device, a touch input device, a location sensor, a camera, a biometric sensor, etc. Output device(s) 2014 such as a display, speakers, a printer, etc. may also be included. The aforementioned devices are examples and others may be used.

Computing device 2000 may also contain a communication connection 2016 that may allow device 2000 to communicate with other computing devices 2018, such as over a network in a distributed computing environment, for example, an intranet or the Internet. Communication connection 2016 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 2004, including operating system 2005. While executing on processing unit 2002, programming modules 2006 (e.g., application 2020 such as a media player) may perform processes including, for example, one or more stages of methods, algorithms, systems, applications, servers, databases as described above. The aforementioned process is an example, and processing unit 2002 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

The following is claimed:

1. A 3D printing device configured for fabricating prosthesis, the 3D printing device comprising:
a communication device communicatively coupled with at least one scanning device, wherein the communication device is configured for receiving at least one scan data from the at least one scanning device; wherein the scanning device is configured to generate the at least one scan data;
a processing device configured for:
analyzing the at least one scan data;
generating, at least one prosthetic fabrication data based on the analyzing;
a 3D printer communicatively coupled with the processing device, wherein the 3D printer is configured for fabricating at least one prosthesis based on the at least one prosthetic fabrication data; and
a storage device is configured for storing the at least one prosthetic fabrication data.

2. The 3D printing device of claim 1 further comprising:
the processing device configured for identifying at least one predetermined prosthetic indication based on the analyzing; and
the storage device configured for retrieving the at least one predetermined prosthetic data from a database based on the at least one predetermined prosthetic indication, wherein the processing device is configured for generating the at least one prosthetic fabrication data based on the at least one predetermined prosthetic data.

3. The 3D printing device of claim 1, wherein the scanning device is configured to scan at least one body part of a patient, wherein the at least one scan data is associated with the at least one body part, wherein the at least one prosthesis is associated with the at least one body part.

4. The 3D printing device of claim 1 further comprising:
the communication device configured for receiving at least one patient data associated with at least one body part of a patient from at least one practitioner device, wherein the at least one prosthesis is associated with the at least one body part; and
the processing device configured for analyzing the at least one patient data.

5. The 3D printing device of claim 1, wherein the 3D printer is configured for fabricating at least one precursor prosthesis, wherein the 3D printer further comprising the processing device configured for generating at least one alignment data based on the analyzing, wherein the 3D printer is configured for fabricating the at least one prosthesis based on the at least one alignment data and the at least one precursor prosthesis.

6. The 3D printing device of claim 1, wherein the at least one prosthesis comprises at least one fabricable polymer material, wherein the 3D printer is configured for fabricating the at least one prosthesis using the at least one fabricable polymer material.

7. The 3D printing device of claim 1 further comprising:
the communication device configured for receiving at least one prosthetic refining data associated with the at least one prosthesis from at least one practitioner device; and
the 3D printer configured for refining the at least one prosthetic based on the at least one prosthetic refining data.

8. The 3D printing device of claim 1, wherein the at least one prosthetic fabrication data comprises a 3D model of the at least one prosthesis, wherein the 3D printer further comprising the communication device configured for transmitting the 3D model to at least one user device, wherein the at least one user device is communicatively coupled with the communication device, wherein the at least one user device is configured to present the 3D model to at least one user.

9. A 3D printing device configured for fabricating dental prosthesis, the 3D printer comprising:
a communication device communicatively coupled with at least one scanning device, wherein the communication device is configured for receiving at least one scan data from the at least one scanning device; wherein the scanning device is configured to generate the at least one scan data;
a processing device configured for:
analyzing the at least one scan data;
generating, at least one prosthetic fabrication data based on the analyzing;
a 3D printer communicatively coupled with the processing device, wherein the 3D printer is configured to fabricate at least one dental prosthesis based on the at least one prosthetic fabrication data; and
a storage device is configured for storing the at least one prosthetic fabrication data.

10. The 3D printing device of claim 9 further comprising:
the processing device configured for identifying at least one predetermined prosthetic indication based on the analyzing; and
the storage device configured for retrieving the at least one predetermined prosthetic data from a database based on the at least one predetermined prosthetic data, wherein the processing device is configured for generating the at least one prosthetic fabrication data based on the at least one predetermined prosthetic data.

11. The 3D printing device of claim 9, wherein the 3D printer is configured for fabricating at least one precursor prosthesis, wherein the 3D printer further comprising the processing device configured for generating at least one alignment data based on the analyzing, wherein the 3D is configured for fabricating the at least one prosthesis based on the at least one alignment data and the at least one precursor prosthesis.

12. The 3D printing device of claim 9 further comprising:
the communication device configured for receiving at least one prosthetic refining data associated with the at least one dental prosthesis from at least one practitioner device; and
the 3D printer configured for refining the at least one dental prosthetic based on the at least one prosthetic refining data.

13. A method for fabricating prosthesis using a 3D printing device, the method comprising:
receiving, using a communication device, at least one scanning data from at least one scanning device, wherein the at least one scanning device is configured to generate the at least one scan data;
analyzing, using a processing device, the at least one scan data;
generating, using the processing device, at least one prosthetic fabrication data based on the analyzing;
transmitting, using the communication device, the at least one prosthetic fabrication data to a 3D printer, wherein the 3D printer is configured to fabricate at least one prosthesis based on the at least one prosthetic fabrication data; and
storing, using a storage device, the at least one prosthetic fabrication data in a database.

14. The method of claim 13 further comprising:
identifying, using the processing device, at least one predetermined prosthetic indication based on the analyzing; and
retrieving, using the storage device, the at least one predetermined prosthetic data from a database based on the at least one predetermined prosthetic indication, wherein the processing device is configured for generating the at least one prosthetic fabrication data based on the at least one predetermined prosthetic data.

15. The method of claim 13, wherein the scanning device is configured to scan at least one body part of a patient, wherein the at least one scan data is associated with the at least one body part, wherein the at least one prosthesis is associated with the at least one body part.

16. The method of claim 13 further comprising:
receiving, using the communication device, at least one patient data associated with at least one body part of a patient from at least one practitioner device, wherein the at least one prosthesis is associated with the at least one body part; and
analyzing, using the processing device, the at least one patient data.

17. The method of claim 13, wherein the 3D printer is configured for fabricating at least one precursor prosthesis, wherein the method further comprising generating, using the processing device, at least one alignment data based on the analyzing, wherein the 3D printer is configured for fabricating the at least one prosthesis based on the at least one alignment data and the at least one precursor prosthesis.

18. The method of claim 13, wherein the at least one prosthesis comprises at least one fabricable polymer material, wherein the 3D printer is configured for fabricating the at least one prosthesis using the at least one fabricable polymer material.

19. The method of claim 13 further comprising:
receiving, using the communication device, at least one prosthetic refining data associated with the at least one prosthesis from at least one practitioner device; and
transmitting, using the communication device, the at least one prosthetic refining data to the 3D printer, wherein the 3D printer configured for refining the at least one prosthetic based on the at least one prosthetic refining data.

20. The method of claim 13, wherein the at least one prosthetic fabrication data comprises a 3D model of the at least one prosthesis, wherein the method further comprising transmitting, using the communication device, the 3D model to at least one user device, wherein the at least one user device is communicatively coupled with the communication device, wherein the at least one user device is configured to present the 3D model to at least one user.
